(19) United States
(12) Patent Application Publication
(10) Pub. No.: US 2009/0160341 A1
(43) Pub. Date: Jun. 25, 2009

(54) DISCHARGE LAMP COMPRISING UV-PHOSPHOR

(75) Inventors: Thomas Jüstel, Witten (DE); Petra Huppertz, Roetgen (DE); Detlef Uwe Wiechert, Alsdorf (DE); Tatjana Rat, Westerkappeln (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/296,670

(22) PCT Filed: Mar. 28, 2007
(86) PCT No.: PCT/IB2007/051089

§ 371 Date: Oct. 10, 2008

(30) Foreign Application Priority Data
Apr. 11, 2006 (EP) 06112503.5

(51) Int. Cl. H01J 61/12

(52) U.S. Cl. 313/637

(57) ABSTRACT

The invention is concerned with a discharge lamp provided with a gas discharge vessel comprising a gas filling with a discharge-maintaining composition, at least part of a wall of the discharge vessel being provided with a luminescent material comprising as a first UV-phosphor a lanthanide-activated lanthanum magnesium aluminate of formula Lai_xMgAlπOic>:Lnx, wherein the lanthanide Ln is selected from the group of Ce(III), Pr(III), Nd(III) and Gd(III), and 0.001<x<0.5, which discharge lamp is further provided with means for generating and maintaining a gas discharge. If it comprises gadolinium as an activator, such a lamp is especially useful for narrow-band UV-B phototherapy. The invention is also concerned with an UV-phosphor in the form of a lanthanide-activated lanthanum magnesium aluminate of formula Lai_xMgAlπOic>:Lnx, wherein the lanthanide Ln is selected from the group of Ce(III), Pr(III), Nd(III) and Gd(III), and 0.001<x<0.5.

### BACKGROUND OF THE INVENTION

The invention relates to a discharge lamp comprising a light-transmitting discharge vessel, said discharge vessel enclosing, in a gastight manner, a discharge space provided with a gas filling. The gas filling comprises at least one discharge-maintaining component in a discharge-maintaining composition. At least part of a wall of the discharge vessel is provided with at least one layer of a luminescent material comprising a UV-phosphor, for converting the high-energy VUV radiation generated by the discharge into UV-B or UV-C radiation. UV-B radiation is the portion of UV radiation in the medium wavelength range of 280 to 320 nm. Such UV-B radiation is useful for e.g. medical or cosmetic purposes. UV-C radiation refers to the portion of the wavelength range from 200 to 280 nm and is especially useful for germicidal purposes and photochemical processes.

This invention relates especially to a discharge lamp having a particular type of luminescent material to emit narrow-band UV-B radiation useful for UV-B phototherapy. Phototherapy, using UV-B radiation, consists of exposing the human skin to UV-B radiation. It has been found to be very effective in the treatment of certain skin conditions, such as psoriasis, vitiligo, eczema and other skin disorders.

To improve the therapeutic effect of UV-B radiation, most fluorescent lamps available for phototherapy are designed to have a narrow-band UV-B spectrum and, therefore, emit predominantly narrow-band UV-B radiation in the range of 310 nanometers to 315 nanometers. It has been demonstrated that radiation with a maximum wavelength in this part of the UV-spectrum is especially effective for treatment of psoriasis. Furthermore, the part of UV-radiation that causes sunburn is absent in a narrow-band UV-B spectrum. So the treatment of patients can be prolonged without causing sunburn to the skin.

The luminescent material for the generation of narrow-band UV-B light in most conventional phototherapy lamps comprises the UV-B-phosphor LaB₃O₆:Bi,Gd, known from GB 1536 637, due to its high efficiency under 185 and 254 nm excitation. It has a maximum peak of emission at about 310 to 313 nm and a half-value width of less than 10 nm.

Like any high-output phosphor-based device, the narrow-band UV-B lamp comprising LaB₃O₆:Bi,Gd as an UV-B phosphor is susceptible to phosphor degradation by the action of short-wave UV radiation. Static high-intensity operation, as is used for UV-B phototherapy, is the kiss of death to phosphors, resulting in a reduction of the electro-optical efficiency in the course of the service life.

Moreover, within discharge lamps, wherein the gas filling comprises mercury, recombination of mercury ions and electrons on the phosphor surface or the incidence of excited mercury atoms and electrons on the phosphor layer causes the emissivity of the phosphors to decrease in the course of time.

A widely applied method of reducing the decrease in UV light output comprises the addition of a protective layer of nanoparticles of Al₂O₃ (alon-c), wherein 1 to 8% alon-c are added to the luminescent material.

A much better approach would be the replacement of the LaB₃O₆:Bi,Gd by a narrow-band UV-phosphor, which is less prone to degradation.

### SUMMARY OF THE INVENTION

The object of the invention is to provide a discharge lamp, particularly for phototherapy and germicidal purposes, which has a higher UV-B or UV-C output, a longer lifetime and improved lumen maintenance.

In accordance with the invention, this object is achieved by a gas discharge lamp provided with a gas discharge vessel comprising a gas filling with a discharge-maintaining composition, at least part of a wall of the discharge vessel being provided with a luminescent material comprising as a first UV-phosphor a lanthanide-activated lanthanum magnesium aluminate of formula La₁₋ₓMgAl₁₁O₁₉:Lnₓ wherein the lanthanide Ln is selected from the group of Ce(III), Pr(III), Nd(III) and Gd(III), and 0.001≦x≦0.5, which discharge lamp is further provided with means for generating and maintaining a discharge.

The invention is based on the recognition that it is bismuth, used as a sensitizer in the host lattice of LaB₃O₆:Bi,Gd, that tends to react with impurities or defects in the host's crystalline structure. Multiplied by static long-time use, this reaction of bismuth rapidly decreases the light output of UV-B lamps.

The phosphor according to the present invention comprises lanthanum in the host lattice. Lanthanum also has a sensitizing function in the light emission, but is much less sensitive to crystalline defects and redox-reactions than bismuth.

The phosphor exhibits high maintenance, that is to say the maintenance of the yield and of the color locus, over the operating time under VUV radiation. In addition, the phosphor exhibits narrow-band UV-emission with little or no emission in the visible range, which is optimal in terms of the efficacy of the discharge lamp.

Due to the high photochemical stability of the luminescent material, the lamps according to the invention are useful for all application areas of UV-radiation in which photo degradation or thermal quenching of the phosphor limits the device performance, e.g. in highly loaded fluorescent lamps.

According to a preferred embodiment of the invention, the discharge lamp comprises mercury in the discharge-maintaining composition. A discharge lamp according to the invention comprising a luminescent material comprising as a first UV-phosphor a lanthanide-activated lanthanum magnesium aluminate of formula La₁₋ₓMgAl₁₁O₁₉:Lnₓ, wherein the lanthanide Ln is selected from the group of Ce(III), Pr(III), Nd(III) and Gd(III), and 0.001≦x≦0.5, appears to be very well resistant to the action of the mercury-rare gas atmosphere which, in operation, prevails in the discharge vessel of the low-pressure mercury vapor discharge lamp. As a result, blackening due to interaction between mercury and the UV-phosphor is reduced, resulting in an improvement of the maintenance. During the service life of the discharge lamp, a smaller quantity of mercury is withdrawn from the discharge, so that, in addition, a reduction of the mercury consumption of the discharge lamp is obtained and in the manufacture of the low-pressure mercury vapor discharge lamp a smaller mercury dose will suffice.

According to another further preferred embodiment of the invention, the discharge-maintaining composition of the discharge lamp comprises an excimer former, such as xenon. In recent years, discharge lamps which emit excimer radiation have become known. Excimers are unstable excited complexes of molecules that under normal conditions possess an unbound or weakly bound ground state. The excimer complexes exist only in the excited state and disintegrate within less than a microsecond. During their decay they give off their binding energy in the form of narrow-band radiation.

The phosphors according to the invention are especially useful when excited by narrow-band radiation provided by an excimer-forming composition due to their narrow band gap.

It may also be preferred that the luminescent material comprises a second UV-phosphor to adjust the lamp spectrum. Such an UV-phosphor may be selected from the group of SrAl₁₂O₁₉:Ce, (La₁₋ₓGdₓ)PO₄:Ce, or a blend thereof.

It may also be preferred that the luminescent material further comprises an additive selected from the group of Al₂O₃, MgO, MgAl₂O₄ and Y₂O₃ to reduce sputtering on the phosphors and the glass walls of the discharge vessel.

The discharge lamp according to the invention may be used preferably for medical purposes, but also for cosmetic and germicidal purposes as well as photochemical processes.

According to a second aspect of the invention, an UV-phosphor, which is a lanthanide-activated lanthanum magnesium aluminate of formula La₁₋ₓMgAl₁₁O₁₉:Lnₓ, wherein the lanthanide Ln is selected from the group of Ce(III), Pr(III), Nd(III) and Gd(III), and 0.001≦x≦0.5, is provided.

An UV-phosphor comprising in a host lattice either cerium, praseodymium, neodymium or gadolinium as an activator and lanthanum(III) as a sensitizer, is a very bright crystalline phosphor, i.e. this UV-radiation-emitting phosphor combines a very good absorption in the VUV range with a very high emission quantum yield of above 80%. Unlike other UV-phosphors, it is hardly degraded by the VUV radiation. It has a longer lifespan and an improved luminance in spite of the fact that it does not contain bismuth.

Especially useful UV-phosphors are La₁₋ₓMgAl₁₁O₁₉:Ceₓ, La₁₋ₓMgAl₁₁O₁₉:Prₓ, La₁₋ₓMgAl₁₁O₁₉: Ndₓ, La₁₋ₓMgAl₁₁O₁₉: Gdₓ, La₁₋ₓMgAl₁₁O₁₉: (Ce,Gd)ₓ, La₁₋ₓMgAl₁₁O₁₉: (Pr,Gd)ₓ, La₁₋ₓMgAl₁₁O₁₉:(Nd,Gd)ₓ, wherein 0.001≦x≦0.5.

It has been found that activation by lanthanides selected from the group of Ce(III), Pr(III), Nd(III) and Gd(III) of the lanthanum magnesium aluminate, results in very efficien luminescent substances, which can be excited by short-wave vacuum ultraviolet radiation as well as by cathode rays and X-rays. The luminescent screens according to the invention have the advantage that the luminescent aluminates have little or no emission band in the visible range of the electromagnetic spectrum.

In accordance with a preferred embodiment of the invention, the UV-phosphor has a grain size of 1 μm<d<20 μm.

A phosphor layer containing an UV-phosphor having a grain size d in the range of 1 μm<d<20 μm forms a very dense layer that satisfactorily shields the phosphor from the mercury plasma. In addition, this very dense layer causes the recombination of mercury ions and electrons on the surface of the phosphor layer to be reduced.

These and other aspects of the invention will be apparent from and elucidated with reference to the embodiment described hereinafter.

### DETAILED DESCRIPTION OF THE INVENTION

While the use of the present phosphor is contemplated for general cosmetic, medical and germicidal purposes, such as sterilization at waterworks and sewage-treatment plants, sterilization of various types of gases and liquids as well as photochemical processing for production, processing and treatment of products, such as lacquers, the present invention is described with particular reference to, and finds particular application in, low-pressure discharge lamps for phototherapy purposes, where a spectrum with a higher amount of narrow-band UV-emission is needed.

Typically, an UV-lamp is a low-pressure mercury vapor discharge lamp. The lighting principle of these UV-lamps is completely the same as that of other known fluorescent lamps. The UV-lamp is only different from the typical fluorescent lamp in that it uses an UV-phosphor film and in that its discharge vessel is made of a glass having a good ultraviolet radiation transmittance, or of fused quartz. In such an ultraviolet radiation lamp, excited mercury atoms emit far ultraviolet rays, which are converted to UV-B and or UV-C radiation by the UV-phosphor.

The majority of presently known and commercially available UV-lamps are of said low-pressure mercury vapor discharge lamp type. But since mercury is a highly poisonous substance, novel types of lamps have been developed recently. One promising candidate to replace mercury-filled lamps is the dielectric barrier discharge (DBD) lamp. Besides eliminating the mercury, it also offers the advantages of long lifetime and negligible warm-up time.

The operating principle of DBD lamps is based on gas discharge in an ionizable discharge medium.

Additionally, a dielectric barrier discharge lamp requires at least one so-called dielectric barrier electrode. A dielectric barrier electrode is separated from the discharge space by means of a dielectric. This dielectric may, for example, be designed as a dielectric layer, which covers the electrode, or alternatively it may be formed by the discharge vessel of the lamp itself, when the electrode is arranged on the outer side of the wall of the discharge vessel.

The ionizable discharge medium of a DBD lamp typically comprises an excimer former, which usually consists of a noble gas, for example xenon, or a gas mixture. During the gas discharge, which is preferably operated by means of a pulsed operating method, excimers are formed. Excimers are excited molecules, e.g. Xe₂*, which emit electromagnetic radiation when they return to the generally unbound ground state. The electromagnetic radiation of the excimers is converted into radiation of longer wavelength by the luminescent material in a physical process similar to that occurring in mercury-filled fluorescent lamps.

FIG. 1 is a diagrammatic cross-sectional view of a dielectric barrier discharge lamp 1 according to the invention. The discharge vessel 2, which is sealed in a vacuum-tight manner, is made of glass and comprises in the discharge space (3) a gas mixture, which forms excimers. The parallel walls (4, 5) of the glass vessel 2 have a wall thickness of 2 mm and are provided with planar electrodes (8, 9) at the surfaces (6, 7) remote from the discharge space (3). The electrode (8) consists of a metal grid, which is transparent to the generated radiation (e.g. gold grid electrode; mesh 1.5 mm). The electrode (9) is a vapour-deposited mirroring aluminium electrode. The spacing between the inner surfaces (10, 11) of the walls (4, 5) is the striking distance d. The linear dimensions of the walls (4, 5) are large in comparison with the striking distance d. The inner surfaces (10, 11) are provided with layers comprising luminescent materials (12, 13).

The flat design shown in FIG. 1 is particularly suitable for phototherapy treatment of skin disorders.

In one preferred embodiment, the DBD lamp according to the invention is filled with xenon, typically with a filling pressure in the range from 50 to 200 mbar, preferably between 100 and 150 mbar. The excimer radiation generated by the glow discharge in the gas mixture changes in dependence upon the composition of the gas in the discharge space. Gas mixtures containing less than 30 vol. % xenon emit substantially resonance radiation at 147 nm. The preferred gas mixtures containing more than 30 vol. % xenon emit excimer radiation at 172 nm.

The advantages of DBD lamps compared to UV-emitting low-pressure mercury discharge lamps are: free design of the lamp geometry (bent, flat, tubular, etc.), long lamp lifetime, no undesirable performance-decreasing emission in the wavelength range from 200 to 800 nm, high efficiency and non-polluting.

The luminescent materials emit UV-B-radiation and/or UV-C radiation upon excitation by the primary radiation of the discharge and comprise a lanthanide-activated lanthanum magnesium aluminate of formula La₁₋ₓMgAl₁₁O₁₉:Lnₓ, wherein the lanthanide Ln is selected from the group of Ce(III), Pr(III), Nd(III) and Gd(III), and 0.001≦x≦0.5.

Different ultraviolet spectral energy distributions are easily obtained by mixing an UV-phosphor according to the invention with a known luminescent material, thus generating different radiation intensities to provide coatings which produce the desired spectrum for general purposes.

In particular SrAl₁₂O₁₉:Ce and (La₁₋ₓGdₓ)PO₄:Ce are well known phosphor materials for producing broadband UV-B radiation, as is SrB₄O₇:Eu, or LaMgAl₁₁O₁₉:Ce for producing UV-A radiation.

These well known UV-producing fluorescent phosphor materials may be mixed in different proportions to produce the desired UV radiation ratio and intensity, and therefore predetermined phototherapy or germicidal strengths. Alternatively, the phosphor coating may consist of a double phosphor layer on the inner wall of the gas discharge vessel, which phosphor layer contains the UV-phosphor according to the invention in one layer and a second UV-phosphor in a second layer.

A second aspect of the present invention focuses on a UV-phosphor consisting of a lanthanide-activated lanthanum magnesium aluminate of formula La₁₋ₓMgAl₁₁O₁₉:Lnₓ, wherein the lanthanide Ln is selected from the group of Ce(III), Pr(III), Nd(III) and Gd(III), and 0.001≦x≦0.5.

The UV-phosphor according to the invention comprises lanthanum magnesium aluminate LaMgAl₁₁O₁₉ as a basic host lattice.

Lanthanum magnesium aluminate LaMgAl₁₁ O₁₉ has a characteristic hexagonal crystal structure, which is basically maintained also on activation by lanthanides selected from the group of Ce(III), Pr(III), Nd(III) and Gd(III) or mixtures thereof.

This hexagonal crystal structures shows a great resemblance to that of the mineral magnetoplumbite or to that of β-alumina. These two hexagonal structures are closely related.

The host lattice LaMgAl₁₁O₁₉ is perfectly suited to absorb VUV photons above 180 nm, since its optical band gap is at around 180 nm (FIG. 2), and it is highly reflective in the range 200 -400 nm. Due to the large band gap, the host lattice does not absorb the radiation emitted from the activators. And the host lattice is relatively stiff, so that lattice vibration, which leads to non-radiative relaxation, which decreases the efficacy, is not easily excited.

Within the three-dimensional network of lanthanum magnesium aluminate LaMgAl₁₁ O₁₉, the activator ions are incorporated and replace part of the lanthanum. The Ce(III), Pr(III), Nd(III) and Gd(III) activator ions may be present as one metal or a mixture of two or more metals.

The excitation band of the phosphors according to the invention is found to be a broad band from 120 to 200 nm. Hence, it is clear that the phosphors can be excited efficiently with radiation of wavelength 185 nm (Hg) as well as 172 nm (Xe). Thus, the luminescent material has ideal characteristics for converting the VUV radiation of a mercury arc discharge or a xenon excimer discharge into UV-B or UV-C radiation.

By a suitable choice of the activator or activator combination, the radiation emitted by the discharge lamp can be given any desired wavelength in the UV-B or UV-C range. For example, said materials are found to emit a narrow band with a peak in the range of 250 nm for high Pr(III)-concentrations and in the range of 310 nm for high Gd(III)-concentrations, as shown in FIGS. 3 and 4 of the drawings accompanying this application.

Especially gadolinium is an excellent activator, because both its ground state and excited states lie within the band gap of about 6 eV of the host lattice Gadolinium absorbs and emits radiation via 4f-5df transitions, i.e. electronic transitions involving f-orbital energy levels. While f-f transitions are quantum-mechanically forbidden, resulting in weak emission intensities, it is known that certain rare earth ions, such as Gd(III) strongly absorb radiation through allowed 4f-5df transitions (via d-orbital/f-orbital mixing) and consequently produce high emission intensities in the UV-B range of the electromagnetic spectrum.

Therefore, LaMgAl₁₁O₁₉ doped with Gd(III) can be used in Xe excimer discharge lamps without any further sensitization, since the host lattice efficiently absorbs incident UV photons from the discharge and transfers the energy to the Gd(III) activator afterwards.

Host lattice+hv→(Host lattice)*

Host lattice+Gd(III)→(Host lattice)+Gd^{3+*}

Gd³⁺*→Gd³⁺+hv (310-312 nm)

However, additional sensitization of Gd(III)-activated luminescent materials is necessary if they are used in a mercury discharge lamp, since this activator does not have any charge transfer or 4f5d states up to 70,000 cm⁻¹ above the ⁸S ground state level of the 4f⁷ configuration. Therefore, it cannot absorb the 254 nm from the low-pressure mercury discharge. By contrast, the chemically stable Ce(III), Pr(III) and Nd(III) are suitable sensitizers for this purpose. They can be used as a sensitizer due to the energetic position of the 4f5d¹ configuration above the ground state (³H₄) of the 4f² configuration. For example, for the free Pr(III) ion, the energy gap between these two states is 62,000 cm⁻¹, which corresponds to 160 nm. This energy gap is reduced in a crystalline environment due the nephelauxetic effect (covalency) and the crystal field splitting of the 5d orbitals.

Thus, this aspect of the invention lies, in part, in the discovery that gadolinium is efficiently sensitized by Ce(III), Pr(III) and Nd(III), when incorporated together into the host material. The additional sensitization enhances the absorption strength of the Gd(III)-activated lanthanum magnesium aluminate at 254 nm and also at 172 nm. The sensitization scheme can be described as follows:

Me³⁺+hv→Me³⁺*(Me=Ce, Pr, Nd)

Me^{3+*}+Gd³⁺→Me³⁺+Gd^{3+*}

Gd³⁺*→Gd³⁺+hv (310-312 nm)

The emission spectra of the UV-B phosphor comprising gadolinium as an activator and praseodymium as a sensitizer resemble those of the UV-B phosphor comprising gadolinium as an activator and bismuth as a sensitizer, i.e. it exhibits a narrow emission band at 311 nm and a half value width of less than 20 nm due to the 4f-4f transitions of Gd(III).

Especially useful narrow-band UV-B phosphors according to the invention are La₁₋ₓMgAl₁₁O₁₉:Ceₓ, La₁₋ₓMgAl₁₁O₁₉:Prₓ, La₁₋ₓMgAl₁₁O₁₉:Ndₓ, La₁₋ₓMgAl₁₁O₁₉:Gdₓ, La₁₋ₓMgAl₁₁O₁₉:(Ce,Gd)ₓ, La₁₋ₓMgAl₁₁O₁₉:(Pr,Gd)ₓ, La₁₋ₓMgAl₁₁O₁₉:(Nd,Gd)ₓ, wherein 0.001≦x≦0.5.

Preferably, the UV-phosphor comprises the activator in an amount of 0.001 to 50 mol % relative to the lanthanum cation in the host lattice and the sensitizer in an amount of 0.001 to 2 mol % relative to the lanthanum cation in the host lattice.

These UV-phosphors are preferably used in a size distribution with an average grain size of 1 to 20 μm. The grain size is determined by the properties of the phosphor to absorb UV radiation and absorb as well as scatter visible radiation, but also by the necessity to form a phosphor coating that bonds well to the glass wall. The latter requirement is met only by very small grains, the light output of which is smaller, however, than that of slightly larger grains.

Lanthanum magnesium aluminate, activated by trivalent cer, praseodymium, neodymium, gadolinium or mixtures thereof, can generally be prepared by a solid-state reaction at a high temperature of a starting mixture comprising oxides or oxide-producing precursor compounds of the desired elements in the quantities suitable for the formation of the desired composition. When praseodymium is used as the activator, this reaction should take place in a weakly reducing atmosphere (for example, nitrogen containing 1-10% by volume of hydrogen or carbon monoxide). It has been found that the reaction temperature is of importance for the formation of the desired aluminate phase. This temperature should lie between 1100° C. and 1400° C. Further, the use of a melting salt or flux (for example, the use of part of the required magnesium in the form of magnesium fluoride) is recommended.

To apply the phosphors to the walls of the gas discharge vessel use is customarily made of a flow coating process. The coating suspensions for the flow coating process contain water or an organic compound, such as butyl acetate, as the solvent. The suspension is stabilized by adding auxiliary agents, for example cellulose derivatives, polymethacrylic acid or polypropylene oxide, and influenced in its rheological properties. Customarily, use is made of further additives such as dispersing agents, defoaming agents and powder conditioning agents, such as aluminum oxide, aluminum oxynitride or boric acid. The phosphor suspension is provided as a thin layer on the inside of the gas discharge vessel by pouring, flushing or spraying. The coating is subsequently dried by means of hot air and burnt in at approximately 600° C. The layers generally have a thickness in the range from 1 to 50 μm.

### SPECIFIC EMBODIMENT 1

### a. Synthesis of LaMgAl₁₁O₁₉:4% Pr

To manufacture the UV-C phosphor LaMgAl₁₁O₁₉:4% Pr, the starting materials 2.047 g (6.282 mmol) La₂O₃, 0.422 g (10.470 mmol) MgO, 0.163 g (2.618 mmol) MgF₂, 7.339 g (71.982 mmol) Al₂O₃, and 0.0891 g (0.0872 mmol) Pr₆O₁₁ are dried at 100° C., milled, and subsequently annealed at 1000° C. for 1 h in a CO-atmosphere. After a thorough grinding step, the powder is annealed twice at 1400° C. for 4 h in a CO-atmosphere with intermittent grinding.

Finally, the powder is milled again, washed in 650 ml water at 60° C. for several hours, and dried at 100° C. Said LaMgAl₁₁O₁₉:4% Pr is crystalline and has an average grain size of 3 to 4 micrometer.

FIG. 3 shows emission, excitation and reflection spectrum of LaMgAl₁₁O₁₉:4% Pr.

### b. UV-C Lamp Comprising LaMgAl₁₁O₁₉:4% Pr

A butyl acetate-based phosphor suspension comprising LaMgAl₁₁O₁₉:4% Pr and 1% alon-c is prepared and sieved through a 36 μm mesh. Using a flow coating-related procedure, the suspension is applied to the inner wall of a 290 (?) glass tube. The viscosity of the suspension is adjusted in a way that the resulting phosphor layer has a screen weight between 0.5 and 3.0 mg/cm².

After the coating processes, organic residues (binder etc.) are removed by an annealing step at 550 to 600° C. The lamp is subsequently filled by a few millibar of argon and with 1 to 50 mg Hg. Finally, electrodes are attached to the lamp and the tube is sealed.

### SPECIFIC EMBODIMENT 2

### a. Synthesis of LaMgAl₁₁O₁₉: 15% Gd

To manufacture the UV-B phosphor LaMgAl₁₁O₁₉: 15% Gd, the starting materials 1.785 g (5.478 mmol) La₂O₃, 0.421 g (10.433 mmol) MgO, 0.163 g (2.608 mmol) MgF₂, 7.314 g (71,731 mmol) Al₂O₃, and 0.378 g (1.043 mmol) Gd₂O₃ are thoroughly mixed in an agate mortar. The obtained powder is dried, milled and subsequently annealed twice for several hours at 1400° C. in an air atmosphere with intermittent grinding. Afterwards, it is ground again, and annealed for 2 h at 1400° C. in air. Finally, the powder is milled again, washed in 650 ml water at 60° C. for several hours, and dried at 100° C. Said LaMgAl₁₁O₁₉: 15% Gd is crystalline and has an average grain size of 3 micrometer.

FIG. 4 shows the emission, excitation and reflection spectrum of LaMgAl₁₁O₁₉:15% Gd.

### b. UV-B Lamp Comprising LaMgAl₁₁O₁₉:15% Gd

A butyl acetate-based phosphor suspension comprising LaMgAl₁₁O₁₉: 15% Gd and 1% alon-c is prepared and sieved through a 36 μm mesh. Using a flow coating-related procedure, the suspension is applied to the inner wall of a 290 (?) glass tube. The viscosity of the suspension is adjusted in a way that the resulting phosphor layer has a screen weight between 0.5 and 3.0 mg/cm².

After the coating processes, organic residues (binder etc.) are removed by an annealing step at 550 to 600° C. The lamp is subsequently filled by a few millibar of argon and with 1 to 50 mg Hg. Finally, electrodes are attached to the lamp and the tube is sealed.

Those skilled in the art will appreciate from the foregoing description that the broad teachings of the present invention can be implemented in a variety of forms. Therefore, while this invention has been described in connection with particular examples thereof, the true scope of the invention should not be limited thereto, since other modifications will become apparent to the skilled practitioner upon a study of the drawings, specification and following claims.

### BRIEF DESCRIPTION OF THE DRAWINGS

In the drawings:

FIG. 1 shows, diagrammatically and in cross-section, a dielectric barrier discharge lamp according to the invention.

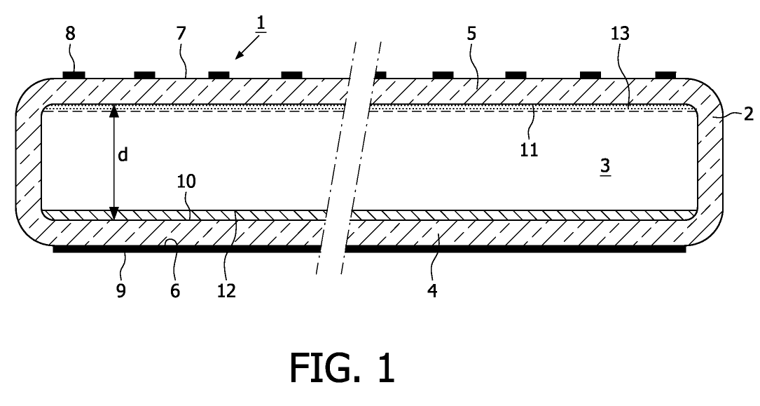

FIG. 2 shows the reflection diagram of LaMgAl ₁₁O₁₉.

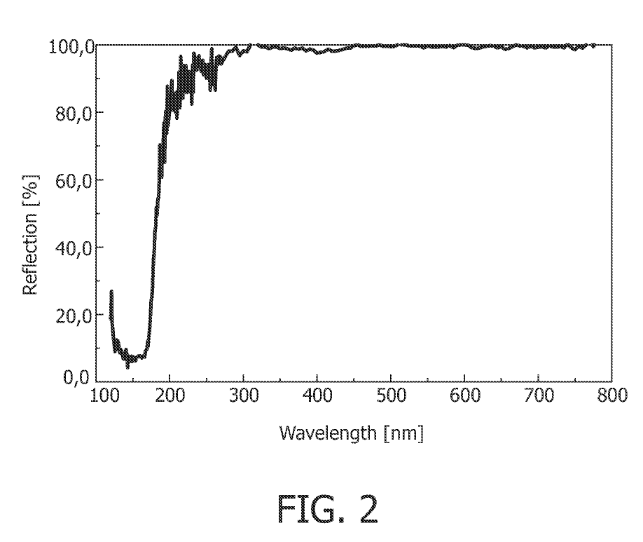

FIG. 3 shows the emission, excitation and reflection spectra of LaMgAl₁₁O₁₉:4% Pr.

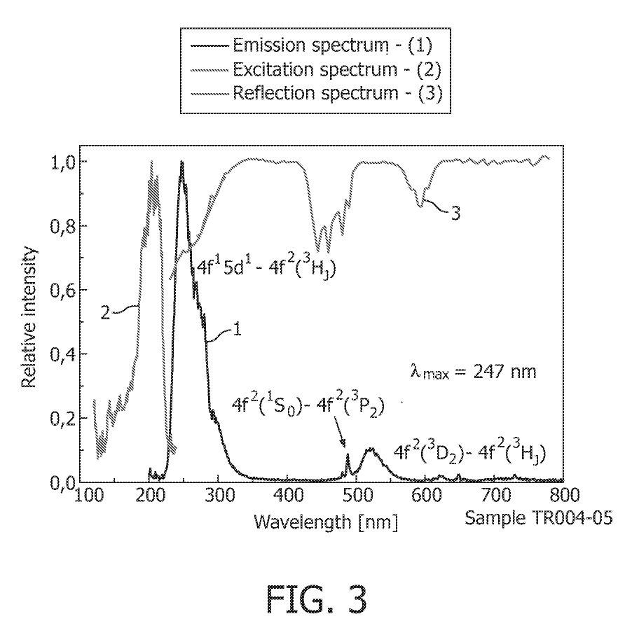

FIG. 4 shows the emission, excitation and reflection spectra of LaMgAl₁₁O₁₉:15% Gd.

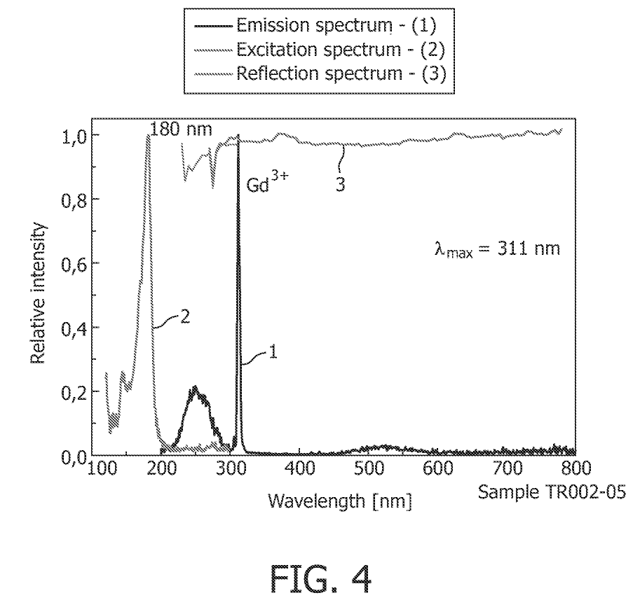

1. A discharge lamp provided with a gas discharge vessel comprising a gas filling with a discharge-maintaining composition, at least part of a wall of the discharge vessel being provided with a luminescent material comprising as a first UV-phosphor a lanthanide-activated lanthanum magnesium aluminate of formula La₁₋ₓMgAl₁₁O₁₉:Lnₓ, wherein the lanthanide Ln is selected from the group of Ce(III), Pr(III), Nd(III) and Gd(III), and 0.001≦x≦0.5, which discharge lamp is further provided with means for generating and maintaining a gas discharge.

2. Discharge lamp as claimed in claim 1, wherein the discharge-maintaining composition comprises mercury.

3. Discharge lamp as claimed in claim 1, wherein the discharge-maintaining composition comprises an excimer former.

4. Discharge lamp as claimed in claim 1, wherein the luminescent material also comprises a second UV-phosphor.

5. Discharge lamp as claimed in claim 4, wherein the second UV-phosphor is selected from the group of SrAl₁₂O₁₉:Ce, (La₁₋ₓGdₓ)PO₄:Ce, or a blend thereof

6. Discharge lamp as claimed in claim 1, wherein the luminescent material further comprises an additive selected from the group of Al₂O₃, MgO, MgAl₂O₄ and Y₂O₃.

7. Use of the discharge lamp as claimed in claim 1 for cosmetic, medical and germicidal purposes and for photochemical processes.

8. UV-phosphor consisting of a lanthanide-activated lanthanum magnesium aluminate of formula La₁₋ₓMgAl₁₁O₁₉:Lnₓ, wherein the lanthanide Ln is selected from the group of Ce(III), Pr(III), Nd(III) and Gd(III), and 0.001≦x≦0.5,

9. UV-phosphor according to claim 8, consisting of a lanthanide-activated lanthanum magnesium aluminate selected from the group of La₁₋ₓMgAl₁₁O₁₉:Ceₓ, La₁₋ₓMgAl₁₁O₁₉:Prₓ, La₁₋ₓMgAl₁₁O₁₉: Ndₓ, La₁₋ₓMgAl₁₁O₁₉ :Gdₓ, La₁₋ₓMgAl₁₁O₁₉:(Ce,Gd)ₓ, La₁₋ₓMgAl₁₁O₁₉:(Pr,Gd)ₓ, La₁₋ₓMgAl₁₁O₁₉:(Nd,Gd)ₓ, wherein 0.001≦x≦0.5.

10. UV-phosphor as claimed in claim 9,
with a size of 1 μm<d<20 μm.
